(19) United States
(12) Patent Application Publication
(10) Pub. No.: US 2008/0320317 A1
(43) Pub. Date: Dec. 25, 2008

(54) Electronic device and information processing method

(75) Inventors: Takeshi Funahashi, Saitama (JP); Takeshi Koyama, Tokyo (JP)

Correspondence Address: WOLF GREENFIELD & SACKS, P.C., 600 ATLANTIC AVENUE, BOSTON, MA, 02210-2206, US

(73) Assignee: Sony Corporation, Tokyo (JP)

(21) Appl. No.: 12/214,083

(22) Filed: Jun. 17, 2008

(30) Foreign Application Priority Data
Jun. 21, 2007 (JP) JP2007-163427

(51) Int. Cl. H04L 9/06

(52) U.S. Cl. 713/189

(57) ABSTRACT

An electronic device is connectable to an information processing apparatus and includes a reading unit to read biologic information; an authentication unit to authenticate a user based on the biologic information; a storage unit including (i) a first storage area that is accessible from the information processing apparatus after authentication has been successfully performed and that stores data supplied from the information processing apparatus with the data being encrypted and (ii) a second storage area storing software that is executed by the information processing apparatus and that has a function of restricting an output destination of data read from the first storage area; a decrypting unit to decrypt the data stored in the first storage area and output the data to the information processing apparatus; and a control unit to control whether the decrypting unit is allowed to decrypt the data in response to instructions from the information processing apparatus.

### CROSS REFERENCES TO RELATED APPLICATIONS

The present invention contains subject matter related to Japanese Patent Application JP 2007-163427 filed in the Japanese Patent Office on Jun. 21, 2007, the entire contents of which are incorporated herein by reference.

### BACKGROUND OF THE INVENTION

1. Field of the Invention

The present invention relates to electronic devices and information processing methods, particularly to an electronic device and an information processing method capable of easily preventing leakage of information due to an act by a user managing the information or an act by a third party that has obtained the information.

2. Description of the Related Art

In recent years, information leakage has made the news frequently. Under such circumstances, many methods for preventing information leakage have been proposed.

For example, information management using a USB (universal serial bus) memory having a fingerprint matching function is very effective for information leakage caused by theft or leaving of a storage medium storing information.

Specifically, data stored in a USB memory having a fingerprint matching function can be read in a personal computer to which the USB memory is connected only after a user whose fingerprint is registered has succeeded in fingerprint authentication. Accordingly, even if a third party gets the USB memory and if he/she tries to improperly read the data stored therein, the data cannot be read, so that information leakage due to an act by the third party can be prevented.

Patent Document 1 (Japanese Unexamined Patent Application Publication No. 2006-146739) discloses a technique for preventing leakage of secret information. In this technique, whether data stored in a removable medium is effective is asked of a management server managing an expiration date of the data. If the removable medium is lost, for example, the data stored in the removable medium is made ineffective regardless of the set expiration date.

On the other hand, Patent Document 2 (Japanese Unexamined Patent Application Publication No. 2007-11511) discloses the following technique. That is, even if secret information in an organization is taken out of the organization and is edited outside the organization, the secret information can be edited in an outside computer while preventing leakage of the information.

### SUMMARY OF THE INVENTION

It is difficult even in the method using a USB memory having a fingerprint matching function to prevent information leakage due to a human operation error or virus infection of a personal computer.

For example, if a user who manages information succeeds in fingerprint authentication in order to edit data, reads the data stored in a USB memory, and stores the data in an HDD (hard disk drive) in a personal computer, it is possible that the user transmits the data with an e-mail by mistake or that the data leaks due to virus infection of the personal computer.

The present invention has been made in view of these circumstances, and is directed to enabling easy prevention of leakage of information due to an act by a user managing the information or an act by a third party that has obtained the information.

An electronic device according to an embodiment of the present invention is connectable to an information processing apparatus and includes reading means for reading biologic information; authentication means for authenticating a user based on the biologic information read by the reading means; storage means including (i) a first storage area that is accessible from the information processing apparatus after authentication has been successfully performed by the authentication means and that stores data supplied from the information processing apparatus with the data being encrypted and (ii) a second storage area storing software that is executed by the information processing apparatus and that has a function of restricting an output destination of data read from the first storage area; decrypting means for decrypting the data stored in the first storage area and outputting the data to the information processing apparatus; and control means for controlling whether the decrypting means is allowed to decrypt the data in response to instructions from the information processing apparatus executing the software stored in the second storage area.

The storage means may further include a third storage area that stores specifying information to specify an output destination of the data read from the first storage area. In this case, in the information processing apparatus executing the software, the output destination of the data read from the first storage area is restricted to an output destination specified by the specifying information stored in the third storage area.

The third storage area may store specifying information to specify an output destination of the data read from the first storage area, the specifying information being set for each of a plurality of information processing apparatuses.

The control means may bring the decrypting means into a state for performing decryption in response to instructions from the information processing apparatus executing the software stored in the second storage area.

The control means may bring the decrypting means into a state for not performing decryption when the electronic device is disconnected from the information processing apparatus.

An information processing method according to an embodiment of the present invention is an information processing method for an electronic device connectable to an information processing apparatus. The electronic device includes reading means for reading biologic information; authentication means for authenticating a user based on the biologic information read by the reading means; storage means including (i) a first storage area that is accessible from the information processing apparatus after authentication has been successfully performed by the authentication means and that stores data supplied from the information processing apparatus with the data being encrypted and (ii) a second storage area storing software that is executed by the information processing apparatus and that has a function of restricting an output destination of data read from the first storage area; and decrypting means for decrypting the data stored in the first storage area and outputting the data to the information processing apparatus. The information processing method includes the step of controlling whether the decrypting means is allowed to decrypt the data in response to instructions from the information processing apparatus executing the software stored in the second storage area.

According to an embodiment of the present invention, whether the decrypting means is allowed to decrypt data is controlled in response to instructions from the information processing apparatus executing the software stored in the second storage area included in the storage means.

According to an embodiment of the present invention, leakage of information due to an act by a user managing the information or an act by a third party that has obtained the information can be easily prevented.

### BRIEF DESCRIPTION OF THE DRAWINGS

FIG. 1 illustrates an example of an appearance of a USB memory having a fingerprint matching function according to an embodiment of the present invention;

FIG. 2 is a block diagram illustrating an example of a hardware configuration of the USB memory;

FIG. 3 illustrates an example of information stored in a flash memory;

FIG. 4 illustrates ON/OFF control of a decrypting module;

FIG. 5 is a block diagram illustrating an example of a hardware configuration of a PC;

FIG. 6 is a block diagram illustrating an example of a functional configuration of the PC;

FIG. 7 is a flowchart illustrating a fingerprint registering process in the USB memory;

FIG. 8 is a flowchart illustrating an authentication process in the USB memory;

FIG. 9 is a flowchart illustrating a data managing process in the USB memory;

FIG. 10 is a flowchart illustrating a process in a master PC;

FIG. 11 is a flowchart illustrating a process in a slave PC;

FIG. 12 illustrates an example of output destinations permitted to the master PC;

FIG. 13 illustrates an example of an output destination permitted to the slave PC;

FIG. 14 illustrates an example of a case where there are a plurality of slave PCs;

FIG. 15 illustrates an example of a case where there area a plurality of master PCs; and

FIG. 16 illustrates another example of the information stored in the flash memory.

### DESCRIPTION OF THE PREFERRED EMBODIMENTS

Before describing an embodiment of the present invention, the correspondence between the features of the claims and the specific elements of an embodiment described in the specification or the drawings is discussed below. This description is intended to assure that an embodiment supporting the claimed invention is described in this specification or the drawings. Thus, even if an element in the following embodiment is not described as relating to a certain feature of the present invention, that does not necessarily mean that the element does not relate to that feature of the claims. Conversely, even if an element is described herein as relating to a certain feature of the claims, that does not necessarily mean that the element does not relate to other features of the claims.

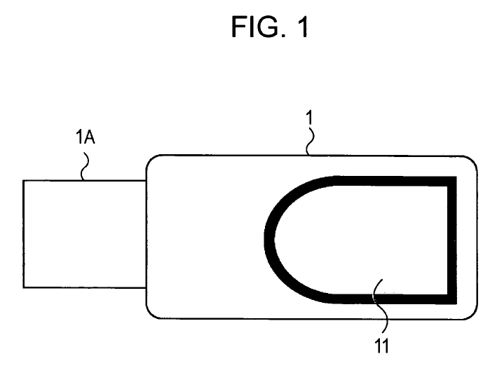

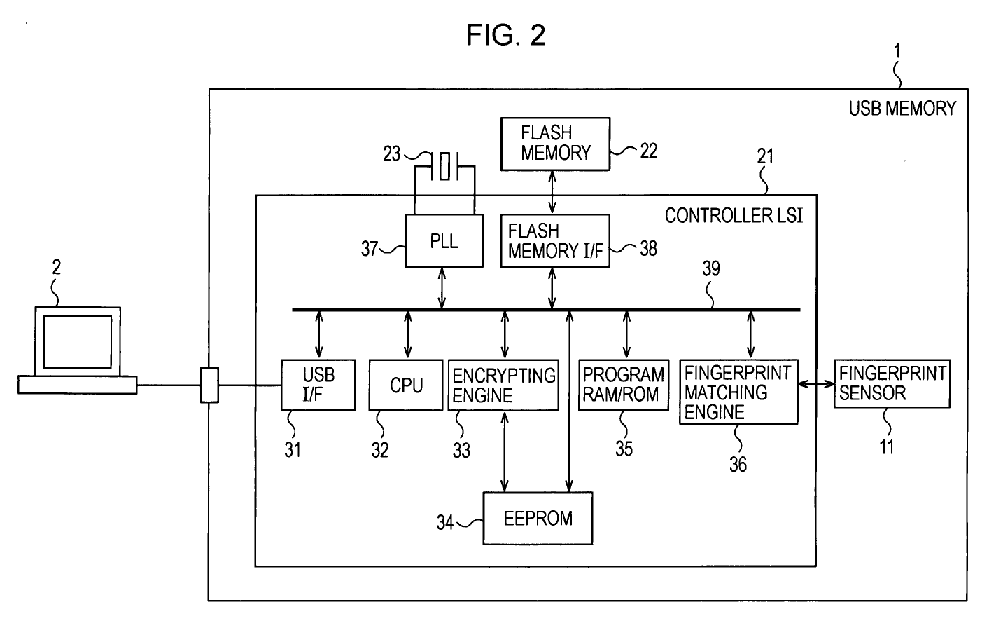

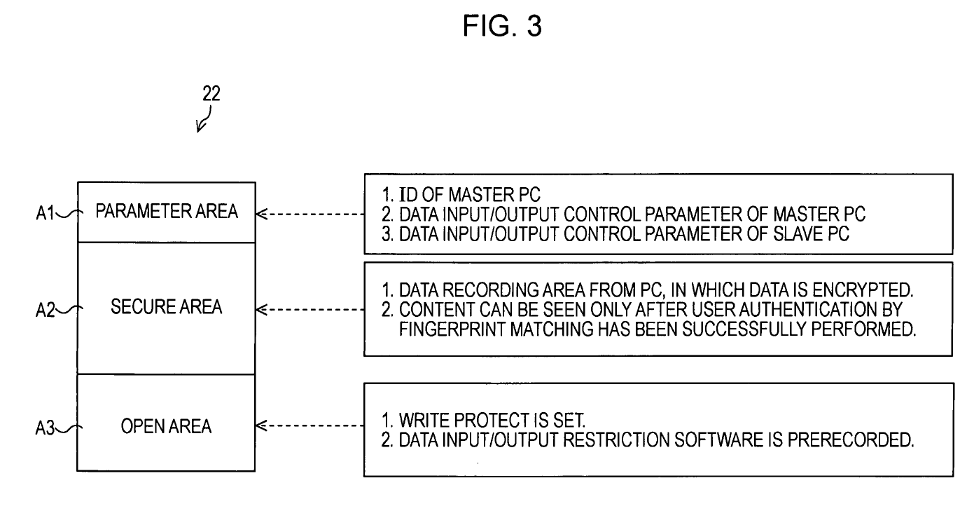

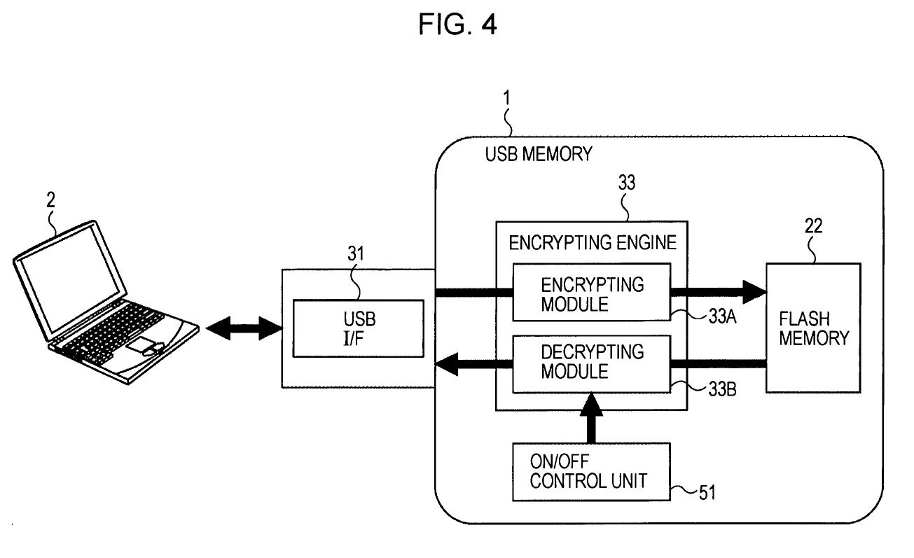

An electronic device according to an embodiment of the present invention (e.g., the USB memory 1 having a fingerprint matching function in FIG. 1) is connectable to an information processing apparatus and includes reading means (e.g., the fingerprint sensor 11 in FIG. 2) for reading biologic information; authentication means (e.g., the fingerprint matching engine 36 in FIG. 2) for authenticating a user based on the biologic information read by the reading means; storage means (e.g., the flash memory 22 in FIG. 2) including (i) a first storage area (e.g., the secure area A2 in FIG. 3) that is accessible from the information processing apparatus after authentication has been successfully performed by the authentication means and that stores data supplied from the information processing apparatus with the data being encrypted and (ii) a second storage area (e.g., the open area A3 in FIG. 3) storing software that is executed by the information processing apparatus and that has a function of restricting an output destination of data read from the first storage area; decrypting means (e.g., the decrypting module 33B in FIG. 4) for decrypting the data stored in the first storage area and outputting the data to the information processing apparatus; and control means (e.g., the ON/OFF control unit 51 in FIG. 4) for controlling whether the decrypting means is allowed to decrypt the data in response to instructions from the information processing apparatus executing the software stored in the second storage area.

The storage means may further include a third storage area (e.g., the parameter area A1 in FIG. 3) that stores specifying information to specify an output destination of the data read from the first storage area.

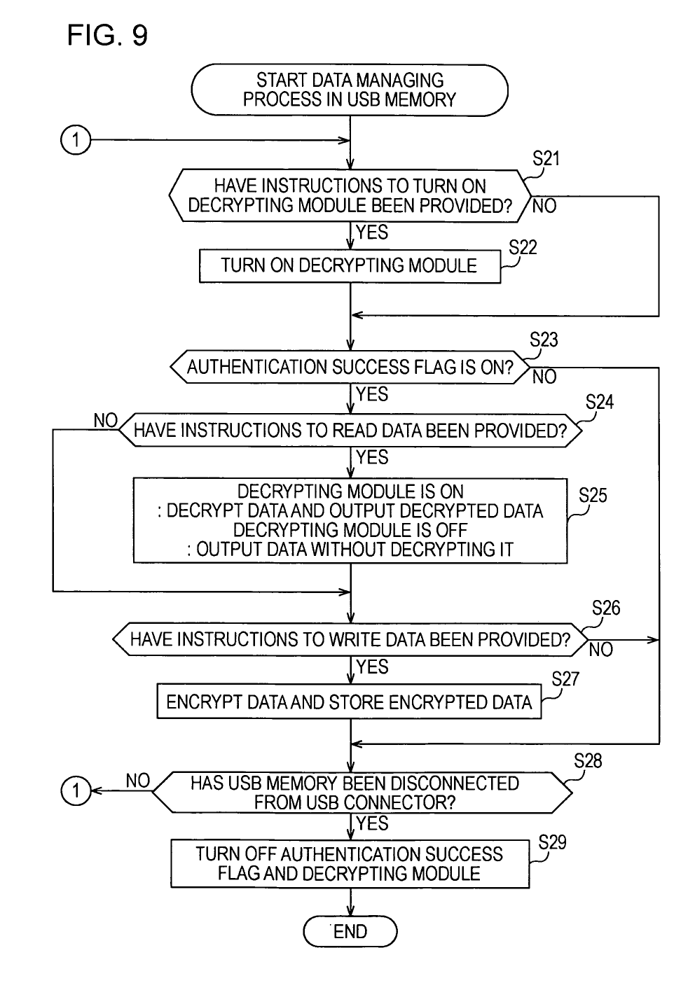

An information processing method according to an embodiment of the present invention is an information processing method for an electronic device connectable to an information processing apparatus. The electronic device includes reading means for reading biologic information; authentication means for authenticating a user based on the biologic information read by the reading means; storage means including (i) a first storage area that is accessible from the information processing apparatus after authentication has been successfully performed by the authentication means and that stores data supplied from the information processing apparatus with the data being encrypted and (ii) a second storage area storing software that is executed by the information processing apparatus and that has a function of restricting an output destination of data read from the first storage area; and decrypting means for decrypting the data stored in the first storage area and outputting the data to the information processing apparatus. The information processing method includes the step of controlling whether the decrypting means is allowed to decrypt the data in response to instructions from the information processing apparatus executing the software stored in the second storage area (e.g., step S22 in FIG. 9).

Hereinafter, an embodiment of the present invention is described with reference to the drawings.

FIG. 1 illustrates an example of an appearance of a USB memory 1 having a fingerprint matching function according to an embodiment of the present invention.

The USB memory 1 having a fingerprint matching function (hereinafter simply referred to as “USB memory 1”) includes a rectangular casing and a USB connector 1A provided on a side surface of the casing. By inserting the USB connector 1A into a USB connector of a PC (personal computer), the USB memory 1 is brought into connection with the PC.

The USB memory 1 includes a flash memory. By inserting the USB memory 1 into the PC and allowing the PC to recognize the USB memory 1 as an external storage medium, a user can store various data created by using the PC in the USB memory 1. In the USB memory 1, the data supplied from the PC is stored in an encrypted state.

A fingerprint sensor 11 is exposed on a surface of the casing of the USB memory 1. Before using the USB memory 1 as an external storage medium of the PC, the user performs fingerprint matching by putting his/her finger on the fingerprint sensor 11 in a state where the USB memory 1 is inserted into the PC. The fingerprint data of the user read by the fingerprint sensor 11 is compared by the USB memory 1 with fingerprint data that is registered in advance by the user and that is stored in the USB memory 1. If the both fingerprint data match, the user can store data in the USB memory 1 from the PC or read data stored in the USB memory 1 by using the PC.

As described above, the USB memory 1 has a function of allowing a user to read data stored therein only after fingerprint authentication has been successfully performed. This function prevents leakage of data stored in the USB memory 1 due to an act by a third party that has obtained the USB memory 1.

Also, the USB memory 1 has a function of turning ON/OFF the state of a decrypting module to decrypt encrypted data in response to instructions from the PC installed with special software stored in the USB memory 1 and executing the software. Although the details are described below, this function prevents leakage of data stored in the USB memory 1 due to an act by a user as an owner of the USB memory 1.

In other words, data leakage can be easily prevented by a combination of the fingerprint authentication function and the function of turning ON/OFF the state of the decrypting module in response to instructions from the PC executing the special software. The special software stored in the USB memory 1 is provided with a function of restricting an output destination of data read from the USB memory 1.

FIG. 2 is a block diagram illustrating an example of a hardware configuration of the USB memory 1. In FIG. 2, parts that are the same as those in FIG. 1 are denoted by the same reference numerals.

In the example illustrated in FIG. 2, a PC 2 serves as a USB host apparatus to which the USB memory 1 is connected. The USB memory 1, which is a USB target device, performs a process in response to a request from the PC 2 connected thereto.

As illustrated in FIG. 2, the USB memory 1 basically includes a controller LSI (large scale integrated circuit) 21 serving as a USB target controller, which connects to the fingerprint sensor 11, a flash memory 22, and a crystal oscillator 23. At least part of those elements operates by using power that is supplied while the USB memory 1 is in connection with a USB connector of the PC 2.

The controller LSI 21 includes a USB I/F (interface) 31, a CPU (central processing unit) 32, an encrypting engine 33, an EEPROM (electrically erasable and programmable read only memory) 34, a program RAM/ROM (random access memory/read only memory) 35, a fingerprint matching engine 36, a PLL (phase lock loop) 37, and a flash memory I/F 38, which are mutually connected through a bus 39.

The USB I/F 31 communicates with the PC 2 along a USB standard. The USB I/F 31 receives data transmitted form the PC 2 and outputs the received data to the bus 39. The data output to the bus 39 is encrypted by the encrypting engine 33, is supplied to the flash memory I/F 38, and is then stored in the flash memory 22.

When the USB I/F 31 is supplied with data that is read by the flash memory I/F 38 from the flash memory 22 and is decrypted by the encrypting engine 33 or encrypted data that has not been decrypted by the encrypting engine 33 through the bus 39, the USB I/F 31 transmits the data to the PC 2.

ON and OFF states of the decrypting module included in the encrypting engine 33 are controlled in response to instructions from the PC 2. In the ON state, data read from the flash memory 22 is decrypted and is then transmitted to the PC 2. In the OFF state, data read from the flash memory 22 is transmitted to the PC 2 without being decrypted. Decryption of data is performed by using an encryption key stored in the EEPROM 34, and thus the content of data transmitted without being decrypted is not seen in the PC 2.

The CPU 32 expands and executes a program stored in the ROM in the program RAM/ROM 35, so as to control an operation of each element connected through the bus 39. For example, the CPU 32 controls access to the flash memory 22 by the PC 2. When the CPU 32 is notified from the fingerprint matching engine 36 that fingerprint authentication has been successfully performed, the CPU 32 permits access to the flash memory 22.

When the encrypting engine 33 is supplied with data to be written from the PC 2 through the bus 39, the encrypting engine 33 encrypts the data by using an encryption key stored in the EEPROM 34 and outputs the encrypted data to the flash memory I/F 38.

When the data stored in the flash memory 22 is read by the flash memory I/F 38 and the read data is supplied to the encrypting engine 33 and when the decrypting module is in the ON state, the encrypting engine 33 decrypts the supplied data by using an encryption key stored in the EEPROM 34, outputs the decrypted data to the USB I/F 31, and allows the USB I/F 31 to transmit the data to the PC 2.

The EEPROM 34 stores encryption keys of RSA (Rivest-Shamir-Aldleman), AES (advanced encryption standard), or DES (data encryption standard). Each of the encryption keys stored in the EEPROM 34 is appropriately read by the encrypting engine 33 and is used to encrypt data or to decrypt encrypted data. The encryption key stored in the EEPROM 34 is generated at fingerprint registration by a user, by using part of data of the registered fingerprint and data that is stored in the EEPROM 34 in advance.

The program RAM/ROM 35 stores programs executed by the CPU 32 and various data used by the CPU 32 to execute various processes.

The fingerprint matching engine 36 determines that a finger has been put on the fingerprint sensor 11 when an integration value of the level of an RF signal, which is output when a fingerprint is read in a plurality of relatively small areas set in the fingerprint sensor 11, exceeds a threshold, and then starts reading the fingerprint.

Then, the fingerprint matching engine 36 performs feature matching on the fingerprint that has been read based an output from the fingerprint sensor 11 by using a fingerprint template stored in the flash memory 22. If the feature of the read fingerprint matches the feature of the fingerprint template, the fingerprint matching engine 36 determines that the user who has put his/her finger on the fingerprint sensor 11 is an authorized user, and notifies the CPU 32 that fingerprint authentication has been successfully performed.

The fingerprint template is stored in the flash memory 22 while being encrypted by an encryption key stored in the EEPROM 34. For fingerprint matching, the fingerprint template decrypted by the encrypting engine 33 using the encryption key is supplied to the fingerprint matching engine 36.

The PLL 37 generates a clock used by each element in the controller LSI 21 to operate based on a clock supplied from the crystal oscillator 23 and supplies the generated clock to each element.

The flash memory I/F 38 controls write of data in the flash memory 22 and read of data stored in the flash memory 22.

For example, the flash memory I/F 38 allows the flash memory 22 to store data that is encrypted by the encrypting engine 33 and that is supplied through the bus 39. Also, the flash memory I/F 38 reads encrypted data stored in the flash memory 22 and outputs the read data to the encrypting engine 33 through the bus 39.

The flash memory 22 stores various data under control by the flash memory I/F 38. The flash memory 22 also stores software that is installed and executed by the PC 2.

The crystal oscillator 23 outputs a clock of a predetermined frequency to the PLL 37.

FIG. 3 illustrates an example of areas in the flash memory 22.

As illustrated in FIG. 3, the entire storage area of the flash memory 22 mainly has three areas: a parameter area A1, a secure area A2, and an open area A3.

The parameter area A1 stores an ID of a PC used as a master PC by a user, a data input/output control parameter for the master PC, and a data input/output control parameter for a slave PC. The parameter area A1 can be accessed only by a PC that is installed with data input/output restriction software as special software stored in the open area A3 and that is executing the software.

Here, the master PC is a PC that is used by the user of the USB memory 1 in his/her company, whereas the slave PC is a PC used by the user of the USB memory 1 in his/her home, for example. The master PC and the slave PC are appropriately set by the user. The USB memory 1 may be connected to the master PC or the slave PC.

The ID of the master PC is stored by the master PC that has been installed with the data input/output restriction software stored in the open area A3. The ID of the master PC is used by a PC to which the USB memory 1 is connected in order to determine whether the PC is the master PC, for example.

If the ID of the master PC is rewritten due to a change of the PC used as a master, all the data stored in the flash memory 22 is erased.

The data input/output control parameter for the master PC stored in the parameter area A1 is a parameter referred to by the master PC executing the data input/output restriction software, and an output destination of the data stored in the secure area A2 of the USB memory 1 is specified by the data input/output control parameter. The data input/output control parameter for the master PC is set by a manager of a company distributing the USB memory 1 as equipment.

For example, when restrictions are set so that data can be stored only in the USB memory 1, the data read from the secure area A2 of the USB memory 1 is stored only in the main memory (RAM) and is used for edit or the like in the master PC by the function of the data input/output restriction software. Edited data can be output only to the USB memory 1 and stored therein, that is, can be returned only to the original storage place by the function of the data input/output restriction software. In other words, storing the edited data in an HDD or the like of the master PC is prohibited.

The data input/output control parameter for the slave PC is a parameter that is referred to by the slave PC executing the data input/output restriction software, and an output destination of the data stored in the secure area A2 of the USB memory 1 is specified by the data input/output control parameter. The data input/output control parameter for the slave PC is also set by the manager of the company distributing the USB memory 1 as equipment.

The secure area A2 is an area that is formatted to be accessed by an OS (operating system) of Windows® or Mac®, and stores data encrypted by using an encryption key stored in the EEPROM 34.

After fingerprint authentication has been successfully performed, the secure area A2 can be accessed from the PC, and data can be stored therein from the PC and the data stored therein can be read by the PC. Note that, when the decrypting module of the encrypting engine 33 is in the OFF state, the PC can read the data stored in an encrypted state in the secure area A2 but does not recognize the content of the data (does not recognize the file system).

Encryption of data to be stored in the secure area A2 and decryption of encrypted data read from the secure area A2 are automatically performed in the USB memory 1 in response to a command transmitted from the PC. Thus, the PC does not need to be aware of an encrypting process at read/write of data.

The open area A3 stores the data input/output restriction software in advance. The open area A3 can be accessed from any PC without fingerprint authentication, and thus the user can install the data input/output restriction software to any PC. Write protect is set to the open area A3 so that the data input/output restriction software is not processed.

The flash memory 22 is also provided with an area that stores data of which information is not transmitted from the USB memory 1 to the PC and that is inaccessible from the PC even after fingerprint authentication has been successfully performed.

This area stores a fingerprint template encrypted by using an encryption key stored in the EEPROM 34 and a secret key (individual key).

The secret key is used to decrypt data that has been encrypted in another apparatus by using a corresponding public key. Also, the secret key is used to generate electronic signature data to be attached to data created by the user using the PC.

As described above, the USB memory 1 stores keys used to realize PKI (public key infrastructure) and keys used to encrypt and decrypt data (both asymmetric and symmetric keys), and has a function as a hardware token.

FIG. 4 illustrates ON/OFF control of the decrypting module included in the encrypting engine 33.

As illustrated in FIG. 4, the encrypting engine 33 includes an encrypting module 33A and a decrypting module 33B.

After the USB memory 1 has been connected to the PC 2 and fingerprint authentication has been successfully performed, the encrypting module 33A encrypts the data to be written supplied from the PC2 by using an encryption key stored in the EEPROM 34, outputs the encrypted data to the flash memory 22 via the bus 39 and the flash memory I/F 38, and allows the secure area A2 to store the data.

When the decrypting module 33B is supplied with encrypted data stored in the secure area A2 via the flash memory I/F 38 and the bus 39 in response to instructions from the PC 2 to read the data and when the decrypting module 33B is in the ON state to perform decryption in accordance with control by an ON/OFF control unit 51, the decrypting module 33B decrypts the supplied encrypted data by using an encryption key stored in the EEPROM 34, outputs the decrypted data to the USB I/F 31, and allows the USB I/F 31 to transmit the data to the PC 2.

The ON/OFF control unit 51 controls ON/OFF states of the decrypting module 33B in response to instructions from the PC 2 executing the data input/output restriction software.

The decrypting module 33B is in the OFF state at a default, e.g., just after the USB memory 1 has been connected to the PC 2. The ON/OFF control unit 51 brings the decrypting module 33B into the ON state in response to instructions from the PC 2 that has started and is executing the data input/output restriction software.

When the USB memory 1 is disconnected from the PC 2, the ON/OFF control unit 51 brings the decrypting module 33B into the OFF state. The ON/OFF control unit 51 is realized when the CPU 32 executes a predetermined program.

The state of the decrypting module 33B is controlled in the above-described manner. Thus, even after the USB memory 1 has been connected to the PC 2 and fingerprint authentication has been successfully performed, if the data input/output restriction software has not started in the PC 2 and if the decrypting module 33B of the USB memory 1 is in the OFF state, the user can allow the PC 2 to read the data stored in the secure area A2 but the file system of the data is unrecognizable, so that the user cannot see the content of the data.

The user can see the content of the data stored in the secure area A2 only after fingerprint authentication has been successfully performed, the data input/output restriction software has been started in the PC 2, and the decrypting module 33B has been brought into the ON state, or after the data input/output restriction software has been started in the PC 2, the decrypting module 33B has been brought into the ON state, and fingerprint authentication has been successfully performed.

In this way, the data input/output restriction software is substantially forced to be executed in order to see the data stored in the secure area A2 of the USB memory 1. Since the data input/output restriction software has a function of restricting an output destination of data, the user is disadvantaged by this restriction of an output destination when the user wants to see the data stored in the secure area A2 of the USB memory 1.

Processes in the USB memory 1 having the above-described configuration are described below with reference to flowcharts.

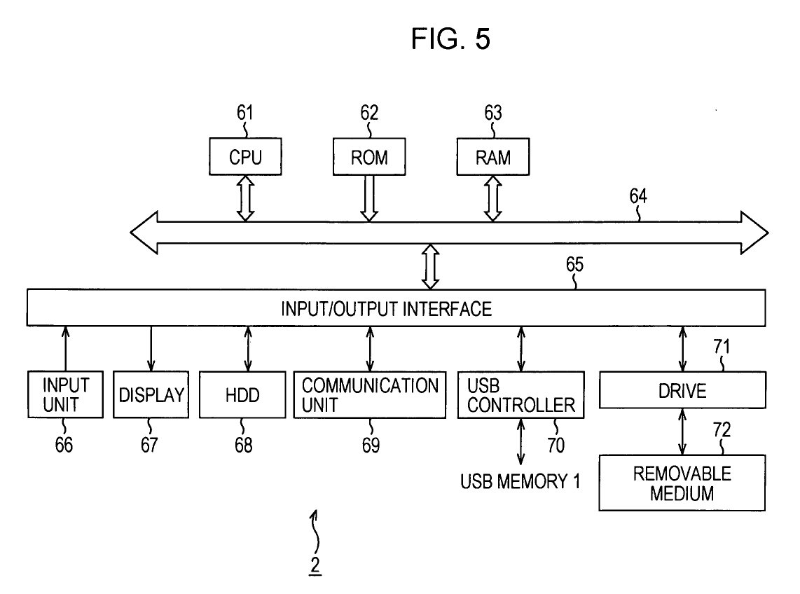

FIG. 5 is a block diagram illustrating an example of a hardware configuration of the PC 2.

A CPU 61 executes various processes in accordance with software stored in a ROM 62 or software loaded from an HDD 68 to a RAM 63. The RAM 63 also stores data used by the CPU 61 to execute various processes. The data input/output restriction software read from the USB memory 1 and installed into the PC 2 is executed by the CPU 61.

The CPU 61, the ROM 62, and the RAM 63 are mutually connected through a bus 64. The bus 64 connects to an input/output interface 65.

The input/output interface 65 connects to an input unit 66 including a keyboard and a mouse, a display 67 including an LCD (liquid crystal display) or the like, the HDD 68 storing various data such as the data input/output restriction software, and a communication unit 69 to communicate with another apparatus via a network.

Also, the input/output interface 65 connects to a USB controller 70 serving as a USB host controller. The USB controller 70 communicates with the USB memory 1 that is connected to the USB connecter provided in the casing of the PC 2.

Also, the input/output interface 65 connects to a drive 71 as necessary, and a removable medium 72, such as a magnetic disk, an optical disc, a magneto-optical disc, or a memory card, is loaded thereto.

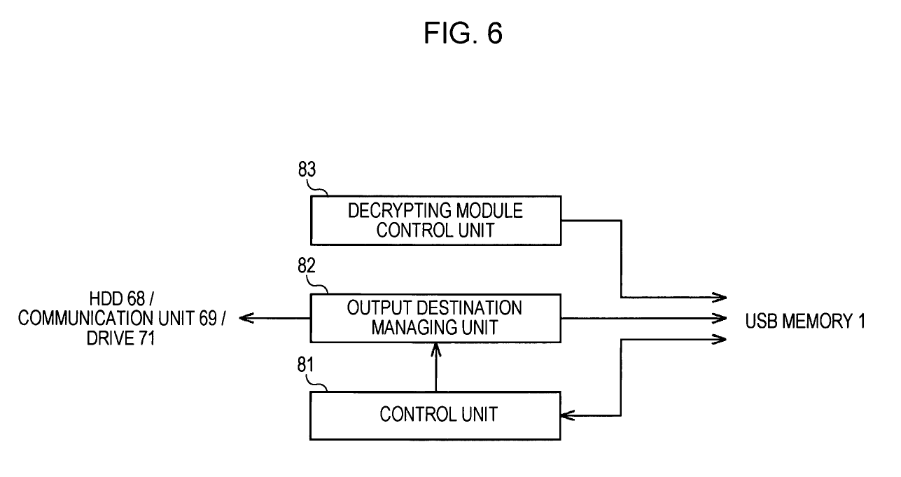

FIG. 6 is a block diagram illustrating an example of a functional configuration of the PC 2.

As illustrated in FIG. 6, in the PC 2 serving as a master PC or a slave PC, a control unit 81, an output destination managing unit 82, and a decrypting module control unit 83 are realized. The output destination managing unit 82 and the decrypting module control unit 83 are realized when the data input/output restriction software that is read from the USB memory 1 and installed is executed by the CPU 61 illustrated in FIG. 5.

The control unit 81 reads and installs the data input/output restriction software stored in the open area A3 of the USB memory 1 when the USB memory 1 is brought into connection with the PC 2.

When the control unit 81 is supplied with decrypted data from the USB memory 1 in accordance with instructions to read the data stored in the secure area A2, the control unit 81 allows the supplied data to be stored in the main memory (the RAM in the program RAM/ROM 35) and performs a predetermined process, such as edit of the data, in accordance with an operation performed by the user. Then, the control unit 81 outputs the processed data to the output destination managing unit 82.

The output destination managing unit 82 manages the output destination of the data that has been read from the secure area A2 of the USB memory 1 and that has been processed by the control unit 81.

For example, the output destination managing unit 82 of the PC 2 serving as a master PC obtains the data input/output control parameter for the master PC stored in the parameter area A1 of the USB memory 1, and outputs the data read from the secure area A2 only to the output destination specified by the obtained data input/output control parameter. Likewise, the output destination managing unit 82 of the PC 2 serving as a slave PC obtains the data input/output control parameter for the slave PC stored in the parameter area A1 of the USB memory 1, and outputs the data read from the secure area A2 only to the output destination specified by the obtained data input/output control parameter.

The decrypting module control unit 83 controls ON/OFF states of the decrypting module 33B by providing instructions to the ON/OFF control unit 51 of the USB memory 1.

Now, processes performed by the USB memory 1 and the PC 2 having the above-described configuration are described.

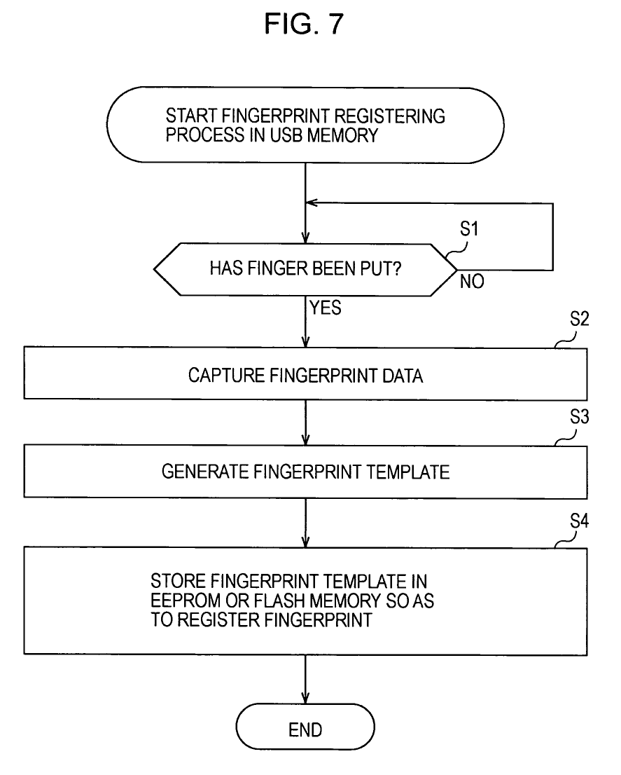

First, a fingerprint registering process in the USB memory 1 is described with reference to the flowchart in FIG. 7.

This process starts when instructions to register a fingerprint are provided from a user through an operation of the PC 2 to which the USB memory 1 is connected. In response to the instructions to register a fingerprint from the user, a command to start registration of the fingerprint is transmitted from the PC 2 to the USB memory 1.

In step S1, the fingerprint matching engine 36 determines whether a finger has been put on the fingerprint sensor 11, or waits until it determines that a finger has been put.

If the fingerprint matching engine 36 determines in step S1 that a finger has been put, the process proceeds to step S2, where the fingerprint matching engine 36 captures an RF signal as fingerprint data supplied from the fingerprint sensor 11.

In step S3, the fingerprint matching engine 36 extracts data representing the feature of the fingerprint read by the fingerprint sensor as a fingerprint template. The fingerprint template generated by the fingerprint matching engine 36 is output to the encrypting engine 33 through the bus 39.

In step S4, the encrypting engine 33 encrypts the fingerprint template by using an encryption key stored in the EEPROM 34 and outputs the encrypted template to the flash memory I/F 38 so that the encrypted template is stored in the flash memory 22. Alternatively, after being encrypted by using the encryption key, the fingerprint template may be stored in the EEPROM 34, instead of in the flash memory 22.

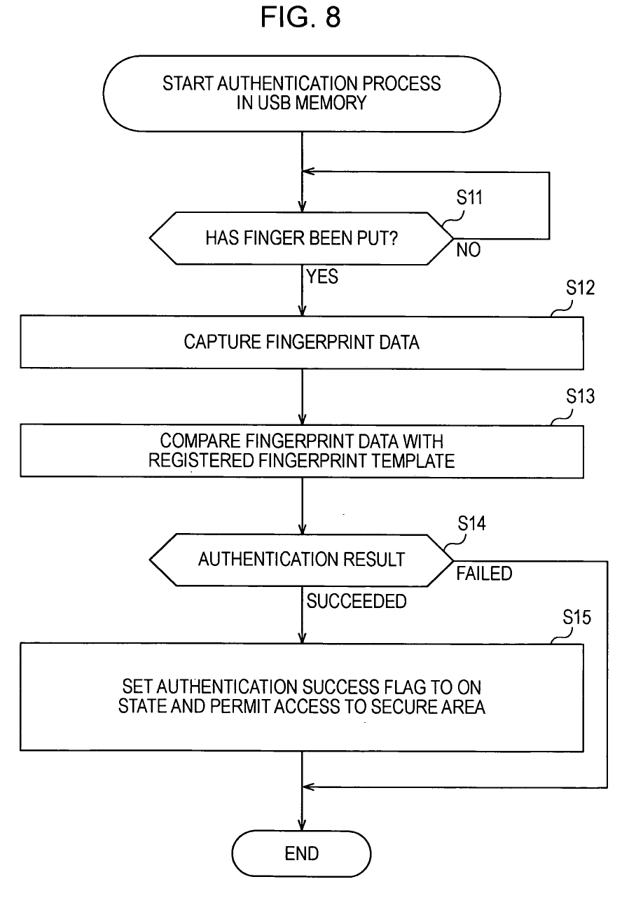

Next, a user authentication process in the USB memory 1 is described with reference to the flowchart in FIG. 8.

This process starts when the USB memory 1 is brought into connection with the USB connector of the PC 2 by the user. When the USB memory 1 is brought into connection with the USB connector of the PC 2, power is supplied from the PC 2 to the USB memory 1, so that the USB memory 1 is brought into an operable state.

In step S11, the fingerprint matching engine 36 determines whether a finger has been put on the fingerprint sensor 11, or waits until it determines that a finger has been put.

If the fingerprint matching engine 36 determines in step S11 that a finger has been put, the process proceeds to step S12, where the fingerprint matching engine 36 captures read fingerprint data based on an RF signal supplied from the fingerprint sensor 11.

In step S13, the fingerprint matching engine 36 regards the fingerprint represented by the read fingerprint data as a fingerprint to be compared, and then compares a feature extracted from the fingerprint with the feature of the fingerprint template that has been decrypted by the encryption key stored in the EEPROM 34 and that has been supplied from the encrypting engine 33.

In step S14, the fingerprint matching engine 36 determines whether authentication has been successfully performed based on a comparison result of the fingerprint features. A determination result indicating whether the authentication has been successfully performed is transmitted to the CPU 32.

If the feature extracted from the fingerprint as a comparison target does not match the feature of the fingerprint template, it is determined in step S14 that the authentication has failed and the process ends.

On the other hand, if it is determined in step S14 that the authentication has succeeded, the process proceeds to step S15, where the CPU 32 sets an authentication success flag to an ON state, which represents success in authentication, and permits the PC 2 to access the secure area A2 of the flash memory 22. Then, the process ends.

Next, a data managing process in the USB memory 1 is described with reference to the flowchart in FIG. 9.

This process starts when the USB memory 1 is brought into connection with the USB connector of the PC 2 by the user and is appropriately performed in parallel with the process illustrated in FIG. 8. As described above, just after the USB memory 1 has been brought into connection with the USB connector of the PC 2, the decrypting module 33B is in the OFF state.

In step S21, the ON/OFF control unit 51 determines whether instructions to turn ON the decrypting module 33B have been provided from the PC 2.

Note that installation of the data input/output restriction software is performed at predetermined timing and that instructions to turn ON the decrypting module 33B are provided from the PC 2 that has been installed with the data input/output restriction software and started the software.

If the ON/OFF control unit 51 determines in step S21 that instructions to turn ON the decrypting module 33B have been provided from the PC 2, the process proceeds to step S22, where the ON/OFF control unit 51 turns ON the decrypting module 33B.

After the decrypting module 33B has been turned ON or if it is determined in step S21 that instructions to turn ON the decrypting module 33B have not been provided from the PC 2, the process proceeds to step S23, where the decrypting module 33B determines whether authentication has been successfully performed in the process illustrated in FIG. 8 and whether the authentication success flag is in the ON state.

If the decrypting module 33B determines in step S23 that the authentication success flag is in the ON state, the process proceeds to step S24, where the decrypting module 33B determines whether instructions to read data have been provided from the PC 2.

If the decrypting module 33B determines in step S24 that instructions to read data have been provided, the process proceeds to step S25. If the decrypting module 33B is in the ON state, the decrypting module 33B decrypts the encrypted data read from the flash memory 22 in response to the instructions from the PC 2 by using the encryption key stored in the EEPROM 34 and outputs the decrypted data to the USB I/F 31 so as to transmit the data to the PC 2. On the other hand, if the decrypting module 33B is in the OFF state, the decrypting module 33B outputs the encrypted data read from the flash memory 22 to the USB I/F 31 without decrypting it so as to transmit the data to the PC 2.

After the data has been transmitted to the PC 2 or if it is determined in step S24 that instructions to read data have not been provided, the process proceeds to step S26, where the encrypting module 33A determines whether instructions to write the data have been provided from the PC 2.

If it is determined in step S26 that instructions to write the data have been provided from the PC 2, the process proceeds to step S27, where the encrypting module 33A encrypts the data to be written supplied from the PC 2 by using an encryption key stored in the EEPROM 34 and stores the encrypted data in the secure area A2 of the flash memory 22.

After the data has been stored in the secure area A2 or if it is determined in step S26 that instructions to write the data have not been provided, the process proceeds to step S28, where the ON/OFF control unit 51 determines whether the USB memory 1 has been disconnected from the USB connector of the PC 2.

If the ON/OFF control unit 51 determines in step S28 that the USB memory 1 has not been disconnected from the USB connector of the PC 2, the process returns to step S21 and the above-described steps are repeated.

On the other hand, if the ON/OFF control unit 51 determines in step S28 that the USB memory 1 has been disconnected from the USB connector of the PC 2, the process proceeds to step S29, where the ON/OFF control unit 51 turns OFF the authentication success flag and the decrypting module 33B and the process ends.

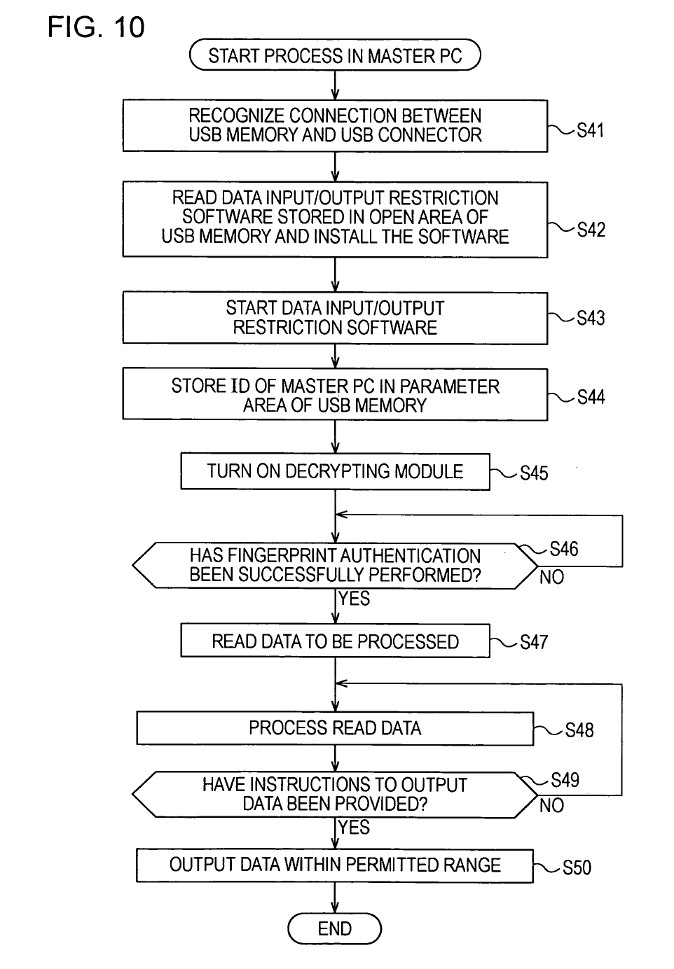

Next, a process performed in the PC 2 as a master PC is described with reference to the flowchart in FIG. 10.

When the USB memory 1 is brought into connection with the USB connector, the control unit 81 of the master PC recognizes the connection in step S41.

In step S42, if the data input/output restriction software has not yet been installed and if instructions to install the software have been provided from the user, the control unit 81 reads the data input/output restriction software stored in the open area A3 of the USB memory 1 and installs the software.

In step S43, the control unit 81 starts the installed data input/output restriction software.

In step S44, if this startup of the data input/output restriction software is the first startup, the control unit 81 outputs an ID of the PC 2, such as a computer name or a serial number, to the USB memory 1 and stores the ID in the parameter area A1. In this way, storage of the ID of the master PC is performed once at the first startup of the data input/output restriction software.

If the ID of the master PC has already been stored, the ID stored in the parameter area A1 of the USB memory 1 is referred to by the control unit 81 when the data input/output restriction software is started, so that the PC 2 recognizes that the PC 2 is the master PC.

In step S45, the decrypting module control unit 83 provides instructions to the ON/OFF control unit 51 of the USB memory 1 in order to turn ON the decrypting module 33B.

In step S46, the control unit 81 transmits an inquiry to the USB memory 1 in order to determine whether fingerprint authentication has been successfully performed, or waits until it determines that fingerprint authentication has been successfully performed.

If the control unit 81 determines in step S46 that fingerprint authentication has been successfully performed, the process proceeds to step S47, where the control unit 81 reads the data to be processed from the secure area A2 of the USB memory 1 by providing instructions to the USB memory 1. Since the decrypting module 33B of the USB memory 1 has been in the ON state, the data to be processed is supplied after being decrypted by the decrypting module 33B so that the control unit 81 can recognize the data.

In step S48, the control unit 81 performs a process on the data read from the USB memory 1 in accordance with the instructions from the user and outputs edited data obtained through the process to the output destination managing unit 82.

In step S49, the output destination managing unit 82 determines whether instructions to output the data have been provided from the user, and allows step S48 to be performed repeatedly until determining that the instructions have been provided.

On the other hand, if the output destination managing unit 82 determines in step S49 that instructions to output the edited data have been provided from the user, the process proceeds to step S50, where the output destination managing unit 82 refers to the data input/output control parameter for the master PC stored in the parameter area A1 of the USB memory 1 and outputs the edited data within a permitted range.

For example, if instructions to output the edited data to the USB memory 1 and to store the data therein again have been provided, the output destination managing unit 82 outputs the edited data to the USB memory 1 and stores the data therein.

On the other hand, if it is permitted to store the data in the HDD 68 as an internal storage medium and if instructions to store the data in the HDD 68 have been provided from the user, the output destination managing unit 82 outputs the edited data to the HDD 68 and stores the data therein.

Furthermore, if it is permitted to output the data to a printer connected to the PC 2 and to print the data and if instructions to print the data have been provided from the user, the output destination managing unit 82 outputs the edited data to the printer and allows the printer to print the data.

After the edited data has been output in the above-described manner, the process ends.

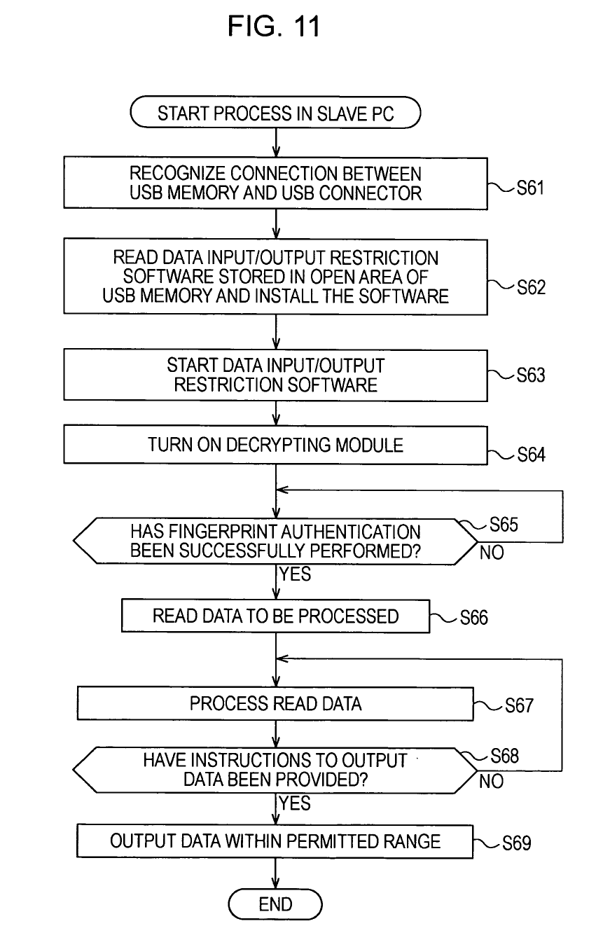

Next, a process performed in the PC 2 as a slave PC is described with reference to the flowchart in FIG. 11.

The process performed in the PC 2 as a slave PC is the same as the process performed in the PC 2 as a master PC illustrated in FIG. 10, except that the ID of the PC 2 is not stored in the USB memory 1.

That is, when the USB memory 1 is brought into connection with the USB connector, the control unit 81 of the slave PC recognizes the connection in step S61.

In step S62, if the data input/output restriction software has not yet been installed and if instructions to install the software have been provided from the user, the control unit 81 reads the data input/output restriction software stored in the open area A3 of the USB memory 1 and installs the software. The user of the USB memory 1 needs to install the data input/output restriction software in the slave PC also when he/she reads the data stored in the secure area A2 of the USB memory 1 in the slave PC.

In step S63, the control unit 81 starts the installed data input/output restriction software.

In accordance with the startup of the data input/output restriction software, the ID of the master PC stored in the parameter area A1 of the USB memory 1 is referred to by the control unit 81, so that the PC 2 recognizes that the PC 2 is a slave PC, not a master PC.

In step S64, the decrypting module control unit 83 provides instructions to the ON/OFF control unit 51 of the USB memory 1 in order to turn ON the decrypting module 33B.

In step S65, the control unit 81 transmits an inquiry to the USB memory 1 in order to determine whether fingerprint authentication has been successfully performed, or waits until it determines that fingerprint authentication has been successfully performed.

If the control unit 81 determines in step S65 that fingerprint authentication has been successfully performed, the process proceeds to step S66, where the control unit 81 reads the data to be processed from the secure area A2 of the USB memory 1 by providing instructions to the USB memory 1.

In step S67, the control unit 81 performs a process on the data read from the USB memory 1 in accordance with the instructions from the user and outputs edited data obtained through the process to the output destination managing unit 82.

In step S68, the output destination managing unit 82 determines whether instructions to output the data have been provided from the user, and allows step S67 to be performed repeatedly until determining that the instructions have been provided.

On the other hand, if the output destination managing unit 82 determines in step S68 that instructions to output the edited data have been provided from the user, the process proceeds to step S69, where the output destination managing unit 82 refers to the data input/output control parameter for the slave PC stored in the parameter area A1 of the USB memory 1 and outputs the edited data within a permitted range.

In this way, in any of the master PC and the slave PC, edited data can be output within the range permitted by the data input/output control parameter dedicated for each of the master and slave PCs stored in the parameter area A1 of the USB memory 1.

Alternatively, a list of all output destinations may be displayed when instructions to output data are provided from the user. If the output destination selected from the list is permitted by a manager, a process of outputting the data may be performed. If the selected output destination is not permitted, a message indicating that fact may be displayed. Alternatively, a list of output destinations permitted by the manager may be displayed when instructions to output the edited data are provided from the user, and an output destination may be selected from the displayed list.

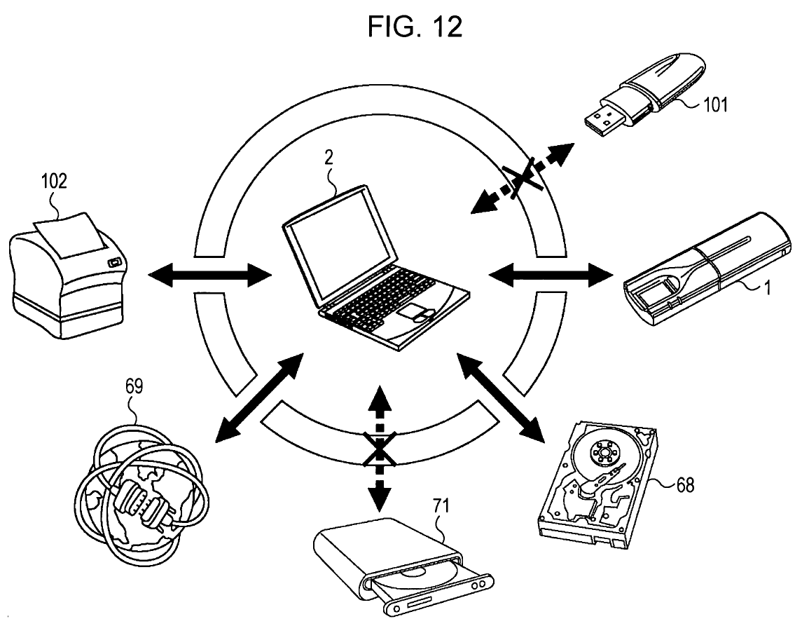

FIG. 12 illustrates an example of output destinations permitted to the master PC.

In the example illustrated in FIG. 12, the followings are permitted: outputting the data read from the secure area A2 of the USB memory 1 to the USB memory 1 and storing the data therein; outputting the data to the internal HDD 68 and storing the data therein; outputting the data to the communication unit 69 and transmitting the data to another apparatus via a network; and outputting the data to a printer 102 and printing the data.

On the other hand, the followings are prohibited: outputting the data read from the secure area A2 of the USB memory 1 to another USB memory 101 and storing the data therein; and outputting the data to the drive 71 and storing the data in a DVD (digital versatile disc) loaded in the drive 71.

The device to which the data can be output and the device to which the data cannot be output are specified by the data input/output control parameter for the master PC.

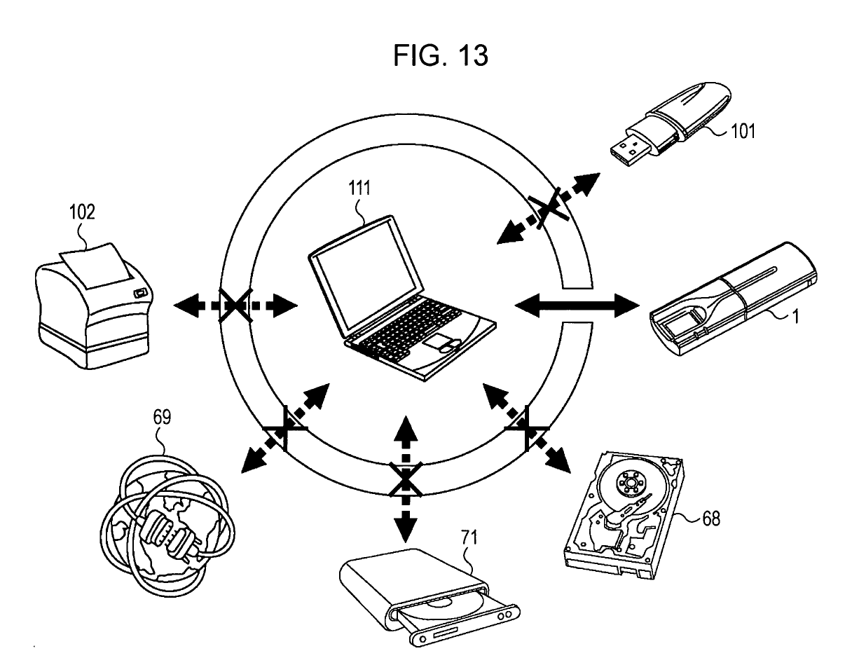

FIG. 13 illustrates an example of an output destination permitted to a slave PC 111.

In the example illustrated in FIG. 13, it is permitted only to output the data read from the secure area A2 of the USB memory 1 to the USB memory 1 as an original storage place and store the data therein.

The device to which the data can be output and the device to which the data cannot be output are specified by the data input/output control parameter for the slave PC.

In this way, the output destination is restricted in the slave PC. Thus, for example, assume that the user stores document data, created by using a PC of the company as a master PC, in the USB memory 1 and brings home the USB memory 1 and that the user edits the document data by using a PC in his/her home as a slave PC. In this case, the output destination of the edited data is restricted to only the USB memory 1. Therefore, leakage of the information from the slave PC due to an act or carelessness of the user of the USB memory 1 can be prevented.

Also, if setting is made so that only the USB memory 1 is permitted as the output destination of the master PC, as well as the slave PC, a system capable of using only the USB memory 1 as a recording medium of data created on business can be constructed.

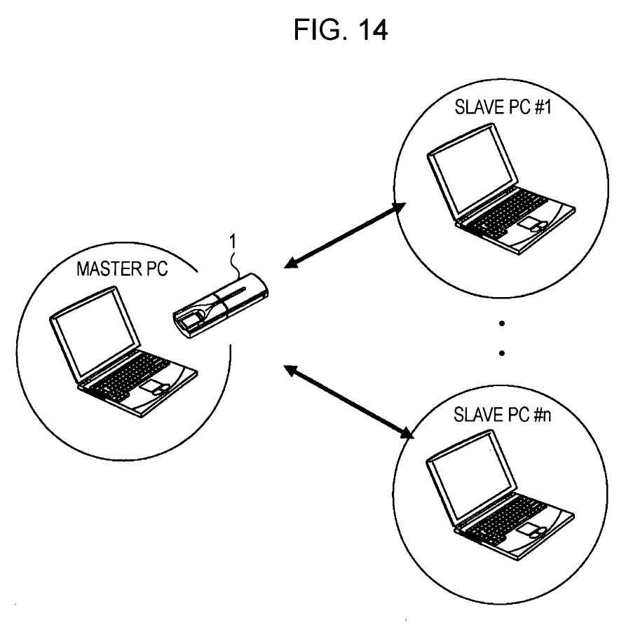

In the above description, one master PC and one slave PC are used. Alternatively, as illustrated in FIG. 14, the USB memory 1 can be used to transmit/receive data between one master PC and n slave PCs (the value of n is not limited).

In this case, the parameter area A1 of the USB memory 1 stores data input/output control parameters that are set for the respective slave PCs and that specify an output destination. The data input/output control parameters are referred to by the respective slave PCs executing the data input/output restriction software. For example, the parameters can be set so that, when the data stored in the secure area A2 of the USB memory 1 from the master PC is read in any of the slave PCs, the data can be output only to the USB memory 1.

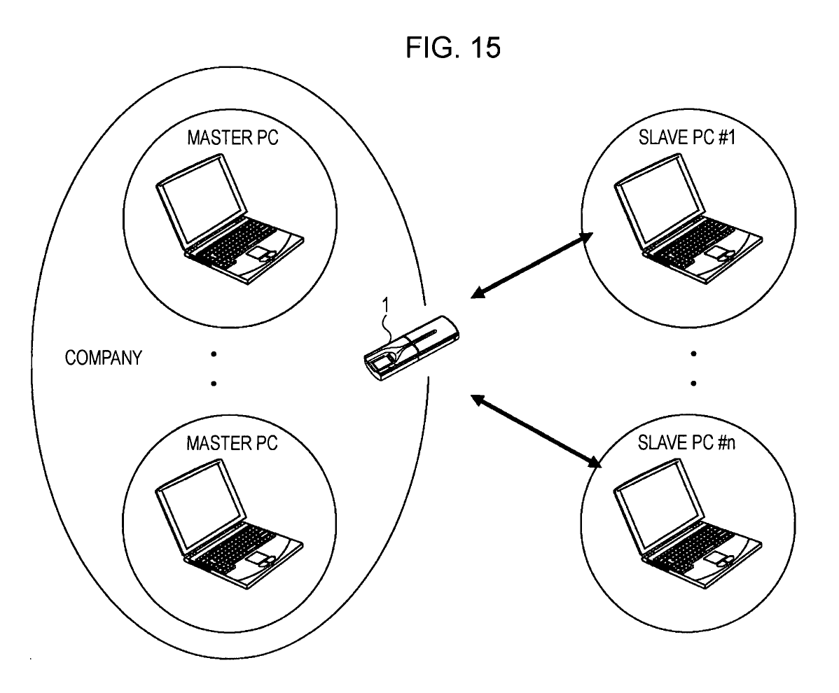

Also, as illustrated in FIG. 15, the USB memory 1 can be used to transmit/receive data by using a plurality of PCs as master PCs.

In this case, the parameter area A1 of the USB memory 1 stores an ID that is assigned as an ID common to the plurality of master PCs. Accordingly, by setting all PCs in a company or all PCs managed by a department as master PCs and storing an ID common to the master PCs, the following system can be realized. That is, users can freely use the data stored in the secure area A2 of the USB memory 1 in the company or in the department, but the users can output the data stored in the secure area A2 of the USB memory 1 only to the USB memory 1 in a PC outside the company or the department.

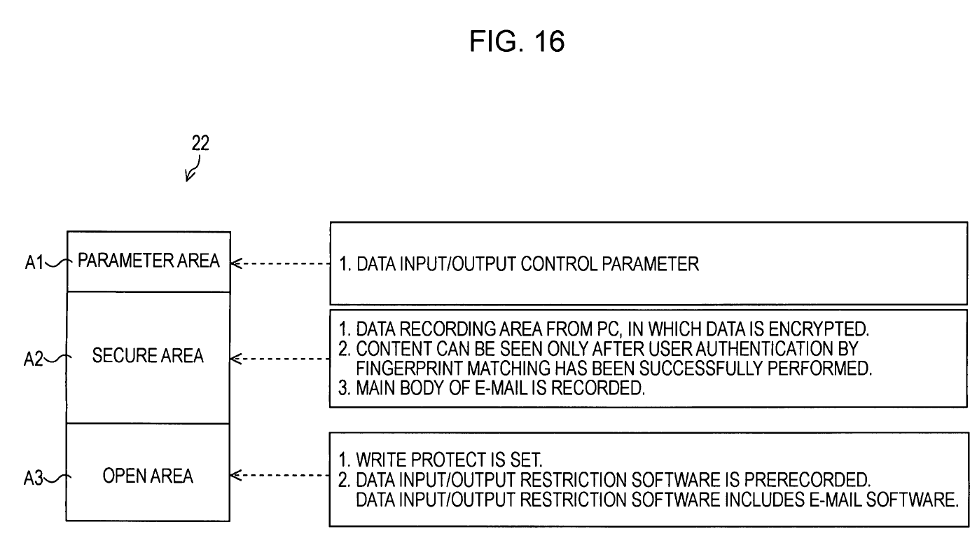

FIG. 16 illustrates an example of information stored in the flash memory 22 of the USB memory 1 when the USB memory 1 is allowed to collaborate with e-mail software.

In the example illustrated in FIG. 16, the output destination of a main body of an e-mail received in e-mail software of the master PC is set to the USB memory 1, and an encrypted main body of an e-mail is stored in the secure area A2.

In this case, the user can read the main body of the e-mail stored in the secure area A2 by using a slave PC by connecting the USB memory 1 to the slave PC, starting the data input/output software stored in the open area A3, and succeeding in fingerprint authentication.

When the data input/output control parameter permits outputting the main body of the e-mail read from the secure area A2 to a network and transmitting the main body as an e-mail, the user can create a response mail to the e-mail of which main body is read by using the slave PC and transmit the response mail from the slave PC. If the main body of the e-mail read from the secure area A2 can be output only by transmitting it as an e-mail, the data of the e-mail does not move to another storage device.

The case where the ON/OFF states of the decrypting module 33B can be controlled has been described above. Alternatively, the ON/OFF states of the encrypting module 33A can be controlled.

In the above description, the data input/output restriction software is provided via the USB memory 1. Alternatively, the software may be provided to the PC 2 by being downloaded from a predetermined server.

Furthermore, in the above description, user authentication is performed by using a fingerprint read by the fingerprint sensor 11. However, the user authentication need not always be performed by using a fingerprint, and another type of biometrics authentication can be performed as long as user authentication can be performed in the USB memory 1. For example, user authentication can be performed by using an iris or a palm print.

When the USB memory 1 is provided with a touch panel, user authentication can be performed by a password that is input by touching the surface of the touch panel with a finger.

The above-described series of processes can be executed by hardware or software. When the series of processes are executed by software, a program constituting the software is installed into a computer incorporated in dedicated hardware or a multi-purpose personal computer capable of executing various functions by being installed with various programs.

The program to be installed and executed is provided by being recorded on the removable medium 72 illustrated in FIG. 5, which is a package medium such as a magnetic disk, an optical disc, a magneto-optical disc, or a semiconductor memory, or is provided via a wired or wireless transmission medium, such as a local area network, the Internet, or digital satellite broadcast. The program can be preinstalled in the ROM 62 or the HDD 68.

The program executed by a computer may be a program in which processes are performed in time series in the order described in this specification, or may be a program in which processes are performed in parallel or at necessary timing, e.g., when a call is performed.

It should be understood by those skilled in the art that various modifications, combinations, sub-combinations and alterations may occur depending on design requirements and other factors insofar as they are within the scope of the appended claims or the equivalents thereof.

What is claimed is:

1. An electronic device connectable to an information processing apparatus, comprising:
reading means for reading biologic information;
authentication means for authenticating a user based on the biologic information read by the reading means;
storage means including (i) a first storage area that is accessible from the information processing apparatus after authentication has been successfully performed by the authentication means and that stores data supplied from the information processing apparatus with the data being encrypted and (ii) a second storage area storing software that is executed by the information processing apparatus and that has a function of restricting an output destination of data read from the first storage area;
decrypting means for decrypting the data stored in the first storage area and outputting the data to the information processing apparatus; and
control means for controlling whether the decrypting means is allowed to decrypt the data in response to instructions from the information processing apparatus executing the software stored in the second storage area.

2. The electronic device according to claim 1,
wherein the storage means further includes a third storage area that stores specifying information to specify an output destination of the data read from the first storage area, and
wherein, in the information processing apparatus executing the software, the output destination of the data read from the first storage area is restricted to an output destination specified by the specifying information stored in the third storage area.

3. The electronic device according to claim 2,
wherein the third storage area stores the specifying information to specify the output destination of the data read from the first storage area, the specifying information being set for each of a plurality of information processing apparatuses.

4. The electronic device according to claim 1,
wherein the control means brings the decrypting means into a state for performing decryption in response to instructions from the information processing apparatus executing the software stored in the second storage area.

5. The electronic device according to claim 1,
wherein the control means brings the decrypting means into a state for not performing decryption when the electronic device is disconnected from the information processing apparatus.

6. An information processing method for an electronic device connectable to an information processing apparatus, the electronic device including
reading means for reading biologic information;
authentication means for authenticating a user based on the biologic information read by the reading means;
storage means including (i) a first storage area that is accessible from the information processing apparatus after authentication has been successfully performed by the authentication means and that stores data supplied from the information processing apparatus with the data being encrypted and (ii) a second storage area storing software that is executed by the information processing apparatus and that has a function of restricting an output destination of data read from the first storage area; and
decrypting means for decrypting the data stored in the first storage area and outputting the data to the information processing apparatus,
the information processing method comprising:
controlling whether the decrypting means is allowed to decrypt the data in response to instructions from the information processing apparatus executing the software stored in the second storage area.

7. An electronic device connectable to an information processing apparatus, the electronic device comprising:
a reading unit configured to read biologic information;
an authentication unit configured to authenticate a user based on the biologic information read by the reading unit;
a storage unit including (i) a first storage area that is accessible from the information processing apparatus after authentication has been successfully performed by the authentication unit and that stores data supplied from the information processing apparatus with the data being encrypted and (ii) a second storage area storing software that is executed by the information processing apparatus and that has a function of restricting an output destination of data read from the first storage area;
a decrypting unit configured to decrypt the data stored in the first storage area and output the data to the information processing apparatus; and
a control unit configured to control whether the decrypting unit is allowed to decrypt the data in response to instructions from the information processing apparatus executing the software stored in the second storage area.
